(19) United States
(12) Patent Application Publication
(10) Pub. No.: US 2008/0049266 A1
(43) Pub. Date: Feb. 28, 2008

(54) IMAGE SENSOR WITHOUT OPTO-MECHANICAL SYSTEM AND MANUFACTURING METHOD THEREOF

(75) Inventor: Kao-Wen Yang, Hsin-Chu Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ADVMATCH TECHNOLOGY, INC., Taipei Hsien (TW)

(21) Appl. No.: 11/927,790

(22) Filed: Oct. 30, 2007

Related U.S. Application Data
(63) Continuation-in-part of application No. 11/774,643, filed on Jul. 9, 2007.

(30) Foreign Application Priority Data
Jul. 7, 2006 (CN) 200610098610.5
Aug. 30, 2006 (CN) 200610111986.5

(51) Int. Cl. H04N 1/40

(52) U.S. Cl. 358/471

(57) ABSTRACT

An image sensor without an opto-mechanical system. The image sensor comprises a substrate, a light source, an optical sensing device and a protective layer. The light source is disposed on the substrate and provides light for image capturing. The optical sensing device is disposed on the substrate and converts a light signal from the light source to an image signal. The protective layer is molded over the light source and the optical sensing device such that an optical path is created therein. No optical-mechanical component exists in the image sensor.

### CROSS REFERENCE TO RELATED APPLICATIONS

This application is a Continuation-In-Part application of pending U.S. patent application Ser. No. 11/774,643, filed on Jul. 9, 2007 and entitled “Image Sensor Without Opto-Mechanical System And Manufacturing Method Thereof,” which claimed priority to China application 200610098610.5, filed on Jul. 7, 2006, and China application 20061011986.5, filed on Aug. 20, 2006.

### BACKGROUND OF THE INVENTION

1. Field of the Invention

The invention relates to an image sensor and, in particular, to an image sensor without an opto-mechanical system.

2. Description of the Related Art

For a conventional semiconductor optical image sensor, an optical-mechanical system is required to capture light beams or optical spots such that an image can be captured. Generally, the optical-mechanical system is very large, thus, making it difficult to shrink the conventional optical image sensor. In fact, the optical-mechanical system requires the largest volume of space in the conventional optical image sensor given current semiconductor manufacturing technology methods. Meanwhile, in addition to combining large-sized lenses, requirements for precise optical-mechanical structures and precise optical guides, make manufacturing of the optical image sensor relatively complicated.

FIG. 1 is a flow chart of a manufacturing method for a conventional optical image sensor. The manufacturing method comprises disposing a light emitting device and a optical sensing device on a substrate (step 101), securing the periphery of the substrate with a plastic frame (step 102), injecting colloid in to the plastic frame (step 103), disposing a lens over the plastic frame and jointing the lens with the periphery with the colloid (step 104), and adjusting the height of the colloid for focusing (step 105).

FIG. 2 is a cross sectional view of a conventional optical image sensor manufactured using the above-mentioned manufacturing method. The conventional optical image sensor comprises a light emitting unit 21 and an optical sensing device 22 on a substrate 23. The periphery of the substrate 23 is secured within a plastic frame 24. A lens 25 is disposed over the plastic frame 24 and jointed with the plastic frame 24 with a colloid 26. Height of the colloid 26 is adjusted for focusing. The conventional optical image sensor is vulnerable to rework adjustments, for example, focus readjustment, due to height and volume limitations.

A semiconductor optical image sensor typically comprises a specific light source. A specific light beam is guided to the optical sensing device along a specific optical path. Meanwhile, an optically designed structure usually has size problems. When light is guided to the optical sensing device, photoelectric conversion is carried out within the internal structure of the optical sensing device. With the specific light beam projected on a specific block of the optical sensing device, an image is captured thereby. Semiconductor optical image capturing methods have been frequently applied in VLSI processes and packaging technologies. Optical sensing devices commonly used are roughly classified into two types, CCD (Charge Coupled Device) and CMOS (Complementary Metal Oxide Semiconductor).

Major packaging methods (the placement of the optical sensing device on a substrate or any other type of electrically conductive carrier) utilized for packaging optical image sensors are COB (Chip on Board) and DCA (Direct Chip Attachment) packaging methods.

Production throughput is typically low due to the slower manufacturing process caused by utilization of large-sized packages. A slower manufacturing process results in excessive particles or precipitates on the optically sensing device, and abnormalities or damage to the optical sensing device during the slower manufacturing process.

As a result, packaging technology for compact optical image sensors have been retarded due to the manufacturing process challenges, excessively large size of the final products or difficulties in photo coupling inherent in opto-mechanical system design. Eventually, space allocation for applied products must be enlarged, thus, hindering smaller-sized designs and causing inconvenience for users, producing an excessively large-sized final product.

### BRIEF SUMMARY OF THE INVENTION

An embodiment of an image sensor comprises a substrate, a light source, an optical sensing device and a protective layer. The light source is disposed on the substrate and provides light for image capturing. The optical sensing device is disposed on the substrate and converts a light signal from the light source to an image signal. The protective layer is molded over the light source and the optical sensing device such that an optical path is created therein. No optical-mechanical component exists in the image sensor.

An embodiment of an image sensor comprises a substrate, a light source, an optical sensing device and a protective layer. The light source is disposed on the substrate and provides light for image capturing. The optical sensing device is disposed on the substrate and converts a light signal from the light source to an image signal. The protective layer is molded over the light source and the optical sensing device such that an optical path is created therein. The protective layer comprises epoxy.

An embodiment of a manufacturing method of an image sensor without an opto-mechanical system comprises disposing a light source, an optical sensing device on a substrate, and performing insert molding to package a protective layer over the light source, and the optical sensing device.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flow chart of a manufacturing method for a conventional optical image sensor;

FIG. 2 is a cross sectional view of a conventional optical image sensor manufactured using the above-mentioned manufacturing method;

FIGS. 3A, 3B and 4 are respectively cross sectional views and a perspective view of an optical image sensor without an optical-mechanical system according to an embodiment of the invention; and

FIG. 5 is a schematic diagram of an optical image sensor with an additional light source according to an embodiment of the invention; and

FIG. 6 is a flow chart of a manufacturing method of the disclosed optical image sensor according to an embodiment of the invention.

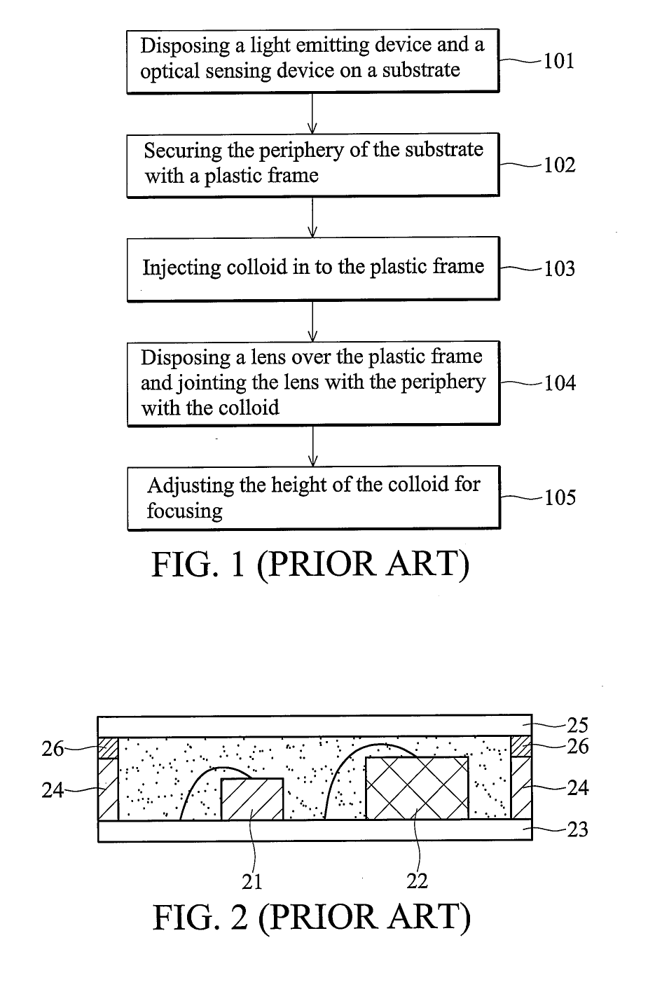

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

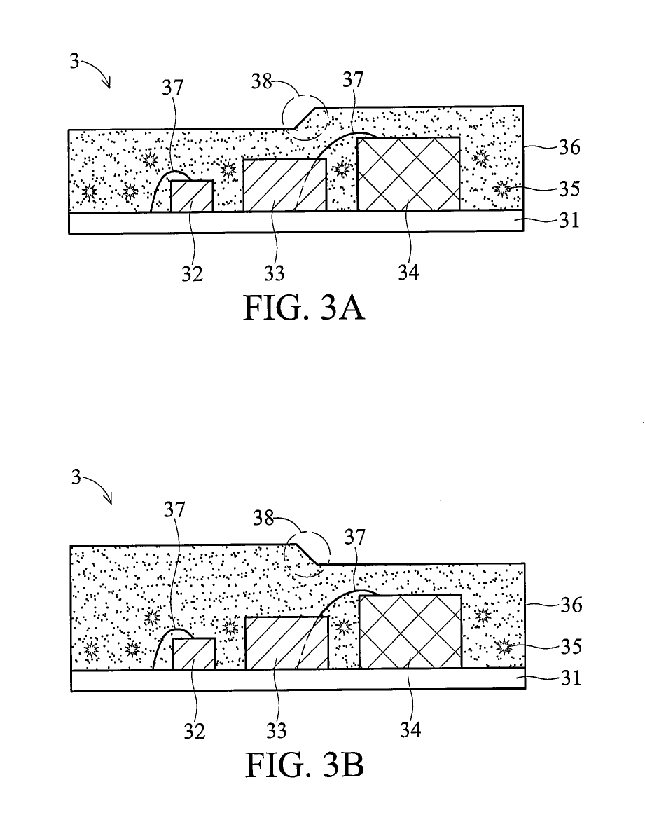

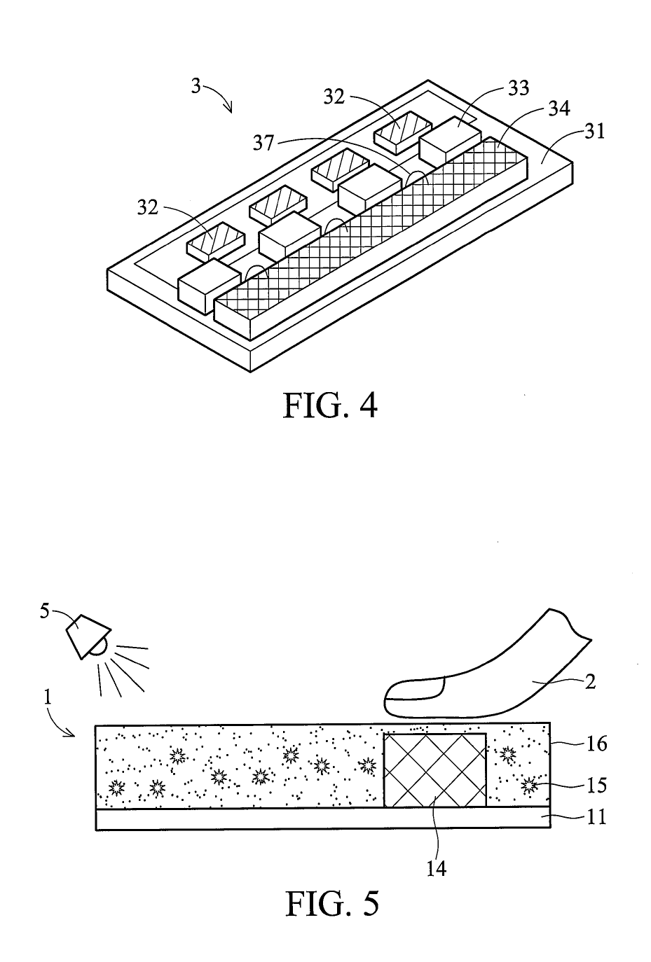

FIGS. 3A, 3B and 4 are respectively a cross sectional view and a perspective view of an optical image sensor without an optical-mechanical system according to an embodiment of the invention. The optical image sensor 3 comprises a substrate 31, an LED 32, an optical sensing device 34, and a protective block 33. The substrate 31 is used to carry the LED 32, the optical sensing device 34 and the protective block 33.

The LED 32 is disposed on the substrate 31 to provide high quality light required for capturing image. Alternatively, a directional light source of multi-mode or single-mode may be used as the light source. The protective block 33 protects the optical sensing device 34 from direct light projection from the LED 32 and also optimizes incident angle of light such that performance of the optical image sensor is improved. The optical sensing device 34 is also disposed on the substrate 31 and receives signals from the specific light source, wherein the signals are converted to digital signals such that an image of the detected object is captured. More specifically, the optical sensing device 34 is a charge coupled device (CCD) or a complementary metal oxide semiconductor (CMOS) sensing device. Alternatively, a plated film or a thin film that blocks permeable specific light source may be printed into the optical sensing device to capture image. The LED 32 and the optical sensing device 34 are packaged on the substrate 31 using welding wires 37 (die up or flip chip). An optical path for a specific light source is formed with a protective layer 36 (made up of high density chemical material) and a conductor 35 which allows transmission of a light source with a specific spectrum and blocks light beams whose frequencies are not in the specific spectrum. The conductor 35 is essentially made up of an optical material such as a high density polymer to provide an optical path specifically designed for the light source such that the optical sensing device 34 can capture the image produced by the specific light source. The protective layer 36 is made up of a high density polymer and blocks the specific light source and any light which is not specifically designed for image capturing such that misjudgment or failure in image capturing of the optical sensing device 34 is avoided. Preferably, the protective layer 36 comprises epoxy. In addition, the protection layer 36 may have a step 38 between the LED 32 and the optical sensing device 34 as shown in FIG. 3A. The step 38 may be helpful for optimizing the optical path and improving performance of the optical image sensor 3. Preferably, the step 38 has a slope such that top surface of the protection layer 36 on a side of the optical sensing device 34 is lower than that on a side of the LED 32, as shown in FIG. 3B.

Embodiments of the invention utilize a high-density chemical material to cover an LED 32 such that an optical path for a specific light source is formed. The light source can be a variable light source or an external light source to provide light required for image capturing. The light source is usually connected directly to the substrate 31 through welding wires 37. Light signals are transmitted via the conductor 35 to the optical sensing device (CCD or CMOS sensor) 34 where the signals are converted to digital signals for image capturing of the detected object.

FIG. 5 is a schematic diagram of an optical image sensor with an additional light source according to an embodiment of the invention. The LED in the optical image sensor of the disclosed embodiments of the invention in FIGS. 3A and 3B is replaced by an external light source 5. As a result, a user is allowed put a finger 6 on a surface of the protective layer 36 for image display without relying upon a lens. Accordingly, size of the packaging structure can be significantly reduced and flattened with the ratio between the captured image and the object approximately at 1:1.

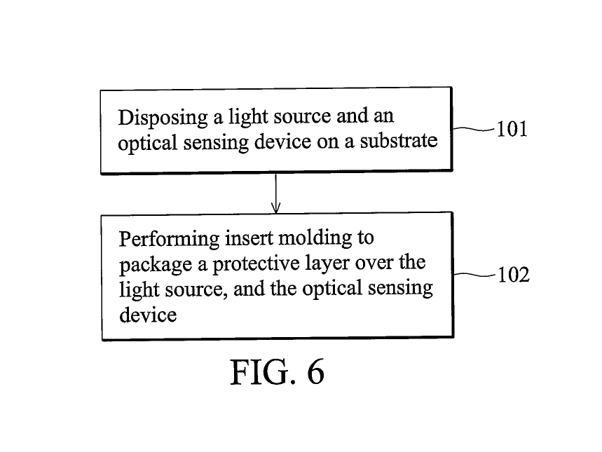

FIG. 6 is a flow chart of a manufacturing method for the disclosed optical image sensor according to an embodiment of the invention. The manufacturing method comprises disposing a light source, an optical sensing device on a substrate (step 601), and performing insert molding to package a protective layer over the light source, and the optical sensing device (step 602). As disclosed previously, an LED, an optical sensing device, and a protective block for blocking specific light source are placed on the substrate. Subsequently, a protective layer which allows transmission of a light source with specific spectrum is integrated with the substrate by insert molding technology to form an independent optical image sensor.

The protective layer is made up of a high-density chemical material and a conductor that allows transmission by a light source with a specific spectrum to define a specific optical path. To obtain the optimal optical path, the protective layer comprised of a high density chemical material has a refraction index not less than 1.5 and a transmission rate greater than 40%. The thickness of the protective layer above the optical sensing device ranges from 5 to 70 μm and that above the LED device ranges from 0.15 to 0.8 mm. The spacing between the optical sensing device and the LED ranges from 0.7 to 2.8 mm.

While the invention has been described by way of example and in terms of preferred embodiment, it is to be understood that the invention is not limited thereto. To the contrary, it is intended to cover various modifications and similar arrangements as would be apparent to those skilled in the Art. Therefore, the scope of the appended claims should be accorded the broadest interpretation so as to encompass all such modifications and similar arrangements.

What is claimed is:

1. An image sensor without an opto-mechanical system, comprising:
a substrate;
a light source disposed on the substrate and providing light for image capturing;
an optical sensing device disposed on the substrate and converting a light signal from the light source to an image signal; and
a protective layer molded over the light source and the optical sensing device such that an optical path is created therein;
wherein no optical-mechanical component exists in the image sensor.

2. The image sensor as claimed in claim 1, further comprising a protective block disposed between the light source and the optical sensing device such that the optical sensing device is protected from direct light projecting from the light source.

3. The image sensor as claimed in claim 1, wherein the protective layer is made up of a high density chemical material.

4. The image sensor as claimed in claim 1, wherein the protective layer is formed by insert molding.

5. The image sensor as claimed in claim 1, wherein the protective layer comprises a conductor allowing light transmission with a specific spectrum and blocking light with frequencies that are not in the specific spectrum.

6. The image sensor as claimed in claim 1, wherein the light source is an LED.

7. The image sensor as claimed in claim 1, wherein the light source is a modulated light source or an external light source.

8. The image sensor as claimed in claim 1, wherein a ratio between a captured image and a detected object is approximately 1:1.

9. The image sensor as claimed in claim 1, wherein the optical sensing device and the light source are electrically connected to the substrate by die-up or flip chip technology.

10. The image sensor as claimed in claim 1, wherein the protection layer has a step between the LED and the optical sensing device.

11. The image sensor as claimed in claim 10, wherein the step has a slope such that top surface of the protection layer on a side of the optical sensing device is lower than that on a side of the LED.

12. An image sensor without an opto-mechanical system, comprising:
a substrate;
a light source disposed on the substrate and providing light for image capturing;
an optical sensing device disposed on the substrate and converting a light signal from the light source to an image signal; and
a protective layer molded over the light source and the optical sensing device such that an optimal optical path is created;
wherein the protective layer comprises epoxy.

13. The image sensor as claimed in claim 12, further comprising a protective block disposed between the light source and the optical sensing device such that the optical sensing device is protected from direct light projecting from the light source.

14. The image sensor as claimed in claim 12, wherein the protective layer is formed by insert molding.

15. The image sensor as claimed in claim 12, wherein the protective layer comprises a conductor allowing light transmission with a specific spectrum and blocking light with frequencies that are not in the specific spectrum.

16. The image sensor as claimed in claim 12, wherein the light source is an LED.

17. The image sensor as claimed in claim 12, wherein the light source is a modulated light source or an external light source.

18. The image sensor as claimed in claim 12, wherein a ratio between a captured image and a detected object is approximately 1:1.

19. The image sensor as claimed in claim 12, wherein the optical sensing device and the light source are electrically connected to the substrate by die-up or flip chip technology.

20. The image sensor as claimed in claim 12, wherein the protection layer has a step between the LED and the optical sensing device.

21. The image sensor as claimed in claim 12, wherein the step has a slope such that top surface of the protection layer on a side of the optical sensing device is lower than that on a side of the LED.

22. A manufacturing method of an image sensor without an opto-mechanical system, comprising:
disposing a light source and an optical sensing device on a substrate; and
performing insert molding to package a protective layer over the light source, and the optical sensing device.

23. The manufacturing method as claimed in claim 22, wherein the protective layer is made up of a high density chemical material.

24. The manufacturing method as claimed in claim 22, wherein the protective layer comprises a conductor allowing light transmission with a specific spectrum and blocking light with frequencies that are not in the specific spectrum.

25. The manufacturing method as claimed in claim 22, wherein a refraction index of the protective layer is not less than 1.5 with transmission rate greater than 40%.

26. The manufacturing method as claimed in claim 22, wherein a thickness of the protective layer above the optical sensing device ranges from 5 to 70 μm.

27. The manufacturing method as claimed in claim 22, wherein thickness of the protective layer above the light source ranges from 0.15 to 0.8 mm.

28. The manufacturing method as claimed in claim 22, wherein a spacing between the optical sensing device and the light source ranges from 0.7 to 2.8 mm.
